(19) United States
(12) Patent Application Publication
(10) Pub. No.: US 2005/0242711 A1
(43) Pub. Date: Nov. 3, 2005

(54) Multi-color solid state light emitting device

(75) Inventor: Joseph Bloomfield, Irwindale, CA (US)

Correspondence Address: CHARLES C.H. WU, 98 DISCOVERY, IRVINE, CA, 92618-3105, US

(73) Assignees: JOSEPH BLOOMFIELD; ALLEN FANN; DANIEL SHIH

(21) Appl. No.: 10/837,262

(22) Filed: Apr. 30, 2004

(51) Int. Cl. H05B 33/00

(52) U.S. Cl. 313/502; 313/501

(57) ABSTRACT

A light emitting device for simulating neon light and method for doing the same. The light emitting device includes an elongated container having a combination of fluorescent pigment and phosphorescent pigment embedded therein. The light emitting device further includes a plurality of light emitting diodes aligned within the container. Finally, the light emitting device includes electrical means for providing electricity to the plurality of diodes.

### BACKGROUND OF THE INVENTION

1. Field of the Invention

The invention relates in general to lighting equipment. More particularly, this invention relates to a device and method that combine light emitting diodes (LEDs) with fluorescent and phosphorescent pigment to simulate neon light.

2. Description of the Related Art

Neon lights have been used for numerous years. They are made of long, narrow glass tubes and come in a variety of shapes. The tube of a neon light can spell out a word, for example.

Inside the glass tube of a neon light, there is a gas such as neon, argon or krypton at low pressure. Both ends of the tube have metal electrodes. When a high voltage is applied to the electrodes, the neon gas ionizes, and electrons flow through the gas. These electrons excite the neon atoms and cause them to emit visible light. Neon emits red light when energized in this way. Other gases emit colors such as blue, green, yellow and white when energized.

Neon lights are typically used in commercial applications such as advertising signs, information displays and backlights. They are generally chosen for their neon affect, or soft glow that demands the viewer's attention.

Neon lights have numerous drawbacks. They are fragile, high voltage, and high energy devices. Neon lights are also monochromatic and do not have an after glow when electrical power is removed. In addition, they have inconsistent life patterns and require licensed tradesmen for installation and replacement.

Therefore, the need arises for a lighting device that produces the attention demanding impact of neon but avoids the drawbacks associated with neon lighting.

In U.S. Pat. No. 6,361,186, Slayden simulates neon light by using light emitting diodes as a light source and a milky clear polyethylene as a diffuser of the light. However, Slayden does not use fluorescent and phosphorescent pigment in the diffuser. The subject invention exposes a tube containing fluorescent and phosphorescent pigment to ultraviolet LEDs to simulate the soft glow of neon light.

### SUMMARY OF THE INVENTION

Accordingly, one object of the present invention is to provide a light emitting device that simulates neon light.

A second object of the invention is to provide a light emitting device that is durable, low voltage and energy efficient.

A third object of the invention is to provide a light emitting device that is chromatically versatile and continues to glow when electrical power is removed.

A fourth object of the invention is to provide a light emitting device that has a long life, and is easy to install and maintain.

To achieve these and other advantages and in accordance with the purpose of the invention, as embodied and broadly described herein, the invention provides a light emitting device for simulating neon light and method for doing the same. The light emitting device includes an elongated container having a combination of fluorescent pigment and phosphorescent pigment embedded therein. The light emitting device further includes a plurality of light emitting diodes aligned within the container. Finally, the light emitting device includes electrical means for providing electricity to the plurality of diodes.

### BRIEF DESCRIPTION OF THE DRAWINGS

FIG. 1 is a perspective view of a tube used in accordance with the present invention.

FIG. 2 is a perspective view of a circuit board with LEDs used in accordance with the present invention.

FIG. 3 is a perspective view of a preferred embodiment of the present invention.

FIG. 4 is a cross-sectional view of a preferred embodiment of the present invention.

FIG. 5 is a side view of the LEDs' positions relative to the tube in a preferred embodiment of the present invention.

FIG. 6 is a side view of the LEDs' positions relative to the tube in an alternative embodiment of the present invention.

### DESCRIPTION OF THE PREFERRED EMBODIMENTS

Referring now to FIG. 1, a perspective view of a tube used in accordance with the present invention is shown. Tube 10 is comprised of a clear carrier mix such as plastic or another similar material. The cross-section of tube 10 can be formed in different shapes, including round, oval, square, rectangle, hexagon and octagon. Tube 10 can also assume different shapes longitudinally, for example, to spell a word. Tube 10 has fluorescent and phosphorescent pigments embedded within it.

Fluorescent pigment is a material made from metallic oxide with rare earth additives. Fluorescent pigment has the property of absorbing ultra-violet light of 360 nm wavelength and immediately emitting visible light. Fluorescent pigment comes in many colors. The pigment can be cast molded, ejection molded, or extrusion molded with different pigment volume to achieve different colors and intensities of color.

Phosphorescent pigment is a powder that continues to radiate visible light after being energized. Electrons of phosphorescent pigment that orbit atoms or molecules absorb energy through collision with photons during excitation. Excess energy is emitted as photons of visible light at a later time. This phosphorescent pigment can be cast, extrusion or ejection molded into tube 10.

Summarizing FIG. 1, tube 10 can be formed into different shapes because it is comprised of plastic or another similar material. Tube 10 is also durable and does not shatter easily. In addition, the fluorescent pigment radiates visible light while tube 10 is energized by an ultraviolet light source. Finally, the phosphorescent pigment allows for continued display of visible light even when ultraviolet light is no longer provided to tube 10.

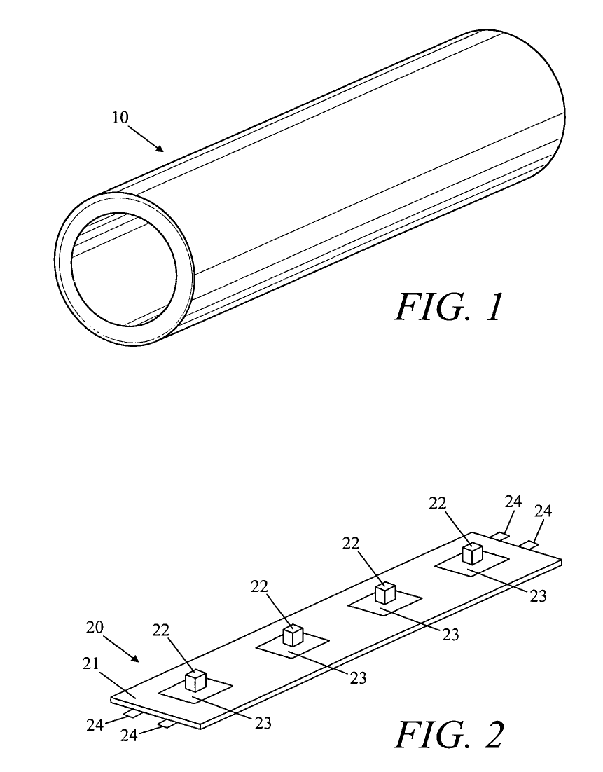

With reference to FIG. 2, a perspective view of a circuit board 20 with LEDs 22 used in accordance with the present invention is shown. Circuit board 20 includes a substrate 21 with circuit pads 23. LEDs 22 are small light bulbs that fit easily into circuit pads 23. Circuit board 20 is shaped to fit within tube 10, and may be formed as a flexible strip. Energy is provided to circuit board 20 via connection points 24.

Unlike ordinary incandescent bulbs, LEDs 22 do not have a filament that will burn out, and do not get especially hot. LEDs 22 are illuminated solely by the movement of electrons in a semiconductor material, and last just as long as a standard transistor. In addition to having long life, LEDs 22 are energy-efficient and low voltage devices.

Still referring to FIG. 2, LEDs 22 emit ultraviolet light. Although solid state devices can emit different colors of light, ultraviolet light has a wavelength best suited for energizing fluorescent and phosphorescent pigments in accordance with the present invention.

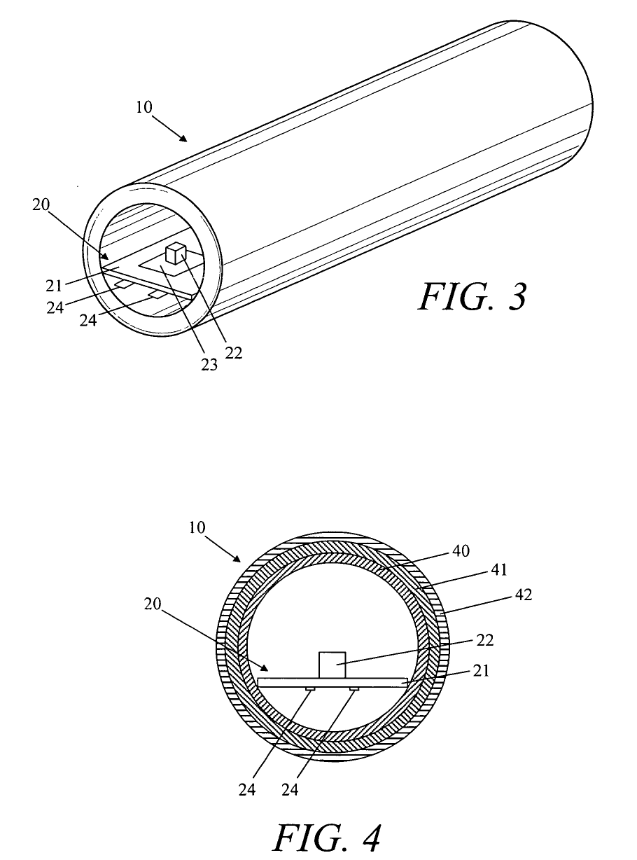

Referring now to FIG. 3, a perspective view of a preferred embodiment of the present invention is shown. In the preferred embodiment, circuit board 20 is positioned within tube 10 to create a light emitting device that simulates the soft glow of neon light. The use of plastic or another similar material for tube 10 allows tube 10 to be formed in different shapes and to securely contain circuit board 20. In addition, a soft clear silicone or solid urethane (not pictured) may be used to fill tube 10. The inner fill holds circuit board 20 for display purposes and when tube 10 is being shaped. The use of solid state circuitry as the light source facilitates installation and maintenance of the light emitting device.

When power is supplied to circuit board 20 via connection points 24, LEDs 22 emit ultraviolet light that energizes tube 10. Because the fluorescent and phosphorescent pigments emit visible light when energized, tube 10 will glow brightly, giving off the affect of neon. When the power is turned off, the phosphorescent pigment provides for continued glowing of tube 10.

With reference to FIG. 4, a cross-sectional view of a preferred embodiment of the present invention is shown. In this embodiment, the cross-sectional shape is circular. However, the cross-section may be oval, square, rectangular, hexagonal, octagonal, etc.

Tube 10 has multiple layers 40, 41 and 42 and is comprised of a clear carrier mix such as plastic or another similar material. Different ratios of fluorescence and phosphorescence within layers 40, 41 and 42 are used to produce different colors and intensities within the visible spectrum of light. In one embodiment, the layers alternate between having fluorescent pigment and phosphorescent pigment.

In the preferred embodiment, tube 10 consists of multiple layers 40, 41 and 42. In an alternative embodiment, tube 10 consists of a single layer with the fluorescent and phosphorescent pigment combining to form a single layer tube.

When power is supplied to connection points 24 and through LEDs 22 to produce ultraviolet light, the fluorescent and phosphorescent pigments are excited, and tube 10 emits the desired color and intensity of light. When power is no longer supplied to connection points 24, the phosphorescent pigment still continues to emit light.

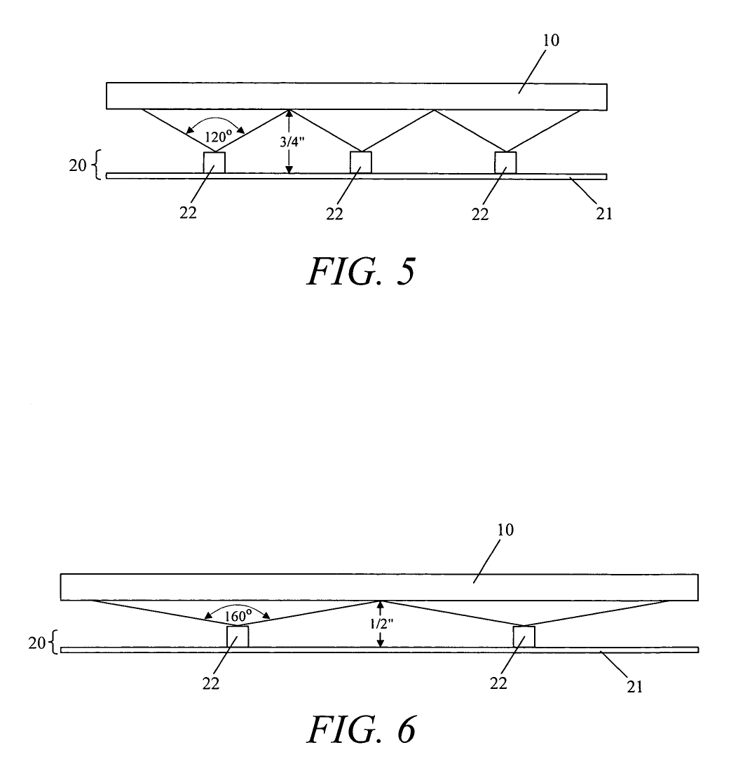

Referring now to FIG. 5, a side view of the LEDs' positions relative to the tube in a preferred embodiment of the present invention is shown. In this embodiment, LEDs 22 emit light at a projection angle of 120°. LEDs 22 are spaced apart from each other so as to minimize overlap of ultraviolet light. The distance between substrate 21 and the top of tube 10 is approximately ¾″. This configuration of LEDs 22 and tube 10 minimizes energy use, allows for uniform lighting of tube 10 and produces the soft glow of neon light.

With reference to FIG. 6, a side view of the LEDs' positions relative to the tube in an alternative embodiment of the present invention is shown. In this embodiment, LEDs 22 emit light at a projection angle of 160°. LEDs 22 are spaced apart from each other so as to minimize overlap of ultraviolet light. The distance between substrate 21 and the top of tube 10 is approximately ½″. This configuration of LEDs 22 and tube 10 minimizes energy use, allows for uniform lighting of tube 10 and produces the soft glow of neon light.

Other embodiments of the invention will appear to those skilled in the art from consideration of the specification and practice of the invention disclosed herein. It is intended that the specification and examples to be considered as exemplary only, with a true scope and spirit of the invention being indicated by the following claims.

1. A light emitting device for simulating neon light comprising:
an elongated container having a combination of fluorescent pigment and phosphorescent pigment embedded therein;
a plurality of light emitting diodes aligned within the container; and
electrical means for providing electricity to the plurality of diodes.

2. The light emitting device according to claim 1 wherein the plurality of diodes produce an ultraviolet light when the electrical means provides electricity to the plurality of diodes, the fluorescent pigment emits visible light during exposure to the ultraviolet light, and the phosphorescent pigment emits visible light during and after exposure to the ultraviolet light.

3. The light emitting device according to claim 1 wherein the fluorescent pigment and the phosphorescent pigment are combined to create different colors of light.

4. The light emitting device according to claim 1 wherein the container is comprised of a clear carrier mix.

5. The light emitting device according to claim 4 wherein the fluorescent pigment and the phosphorescent pigment are embedded into the clear carrier mix by a process selected from the group consisting of cast molding, ejection molding and extrusion molding.

6. The light emitting device according to claim 1 wherein the container can be formed into different cross-sectional and longitudinal shapes.

7. The light emitting device according to claim 1 wherein the container is formed to secure the plurality of diodes.

8. The light emitting device according to claim 1 wherein an inner fill secures the plurality of diodes within the container.

9. The light emitting device according to claim 8 wherein the inner fill is a material selected from the group consisting of soft clear silicone and solid urethane.

10. The light emitting device according to claim 1 wherein the container comprises multiple layers.

11. The light emitting device according to claim 10 wherein the multiple layers alternate between having fluorescent pigment and phosphorescent pigment.

12. The light emitting device according to claim 1 wherein the container comprises one layer.

13. The light emitting device according to claim 1 wherein the diodes are aligned on a circuit board, the circuit board having connection points for contacting the electrical means, the circuit board shaped to fit within the container.

14. The light emitting device according to claim 13 wherein the circuit board is formed with a flexible material.

15. The light emitting device according to claim 1 wherein the plurality of diodes are spaced apart so as to minimize overlap of ultraviolet light within the container.

16. A method for simulating neon light, the method comprising the steps of:
embedding an elongated container with a combination of fluorescent pigment and phosphorescent pigment;
aligning a plurality of light emitting diodes within the container; and
providing electricity to the plurality of diodes.

17. The method according to claim 16 wherein the plurality of diodes produce an ultraviolet light when electricity is provided to the plurality of diodes, the fluorescent pigment emits visible light during exposure to the ultraviolet light, and the phosphorescent pigment emits visible light during and after exposure to the ultraviolet light.

18. The method according to claim 16 wherein the fluorescent pigment and the phosphorescent pigment are combined to create different colors of light.

19. The method according to claim 16 wherein the container is comprised of a clear carrier mix.

20. The method according to claim 19 wherein the fluorescent pigment and the phosphorescent pigment are embedded into the clear carrier mix by a process selected from the group consisting of cast molding, ejection molding and extrusion molding.

21. The method according to claim 16 wherein the container can be formed into different cross-sectional and longitudinal shapes.

22. The method according to claim 16 wherein the container is formed to secure the plurality of diodes.

23. The method according to claim 16 wherein an inner fill secures the plurality of diodes within the container.

24. The method according to claim 23 wherein the inner fill is a material selected from the group consisting of soft clear silicone and solid urethane.

25. The method according to claim 16 wherein the container comprises multiple layers.

26. The method according to claim 25 wherein the multiple layers alternate between having fluorescent pigment and phosphorescent pigment.

27. The method according to claim 16 wherein the container comprises one layer.

28. The method according to claim 16 wherein the diodes are aligned on a circuit board, the circuit board having connection points for contacting the electrical means, the circuit board shaped to fit within the container.

29. The method according to claim 28 wherein the circuit board is formed with a flexible material.

30. The method according to claim 16 wherein the plurality of diodes are spaced apart so as to minimize overlap of ultraviolet light within the container.
